(19) United States
(12) Patent Application Publication
(10) Pub. No.: US 2016/0304396 A1
(43) Pub. Date: Oct. 20, 2016

(54) MAGNESIUM-BASED CEMENTS AND SLURRY PRECURSORS FOR THE SAME

(71) Applicant: Premier Magnesia, LLC, West Conshohocken, PA (US)

(72) Inventors: Mark Alexander Shand, Arden, NC (US); C. Matt Haynes, Waynesville, NC (US); Paul Douglas Jones, Lake Junaluska, NC (US); William David Warren, Canton, NC (US)

(21) Appl. No.: 15/131,331

(22) Filed: Apr. 18, 2016

Related U.S. Application Data
(60) Provisional application No. 62/148,285, filed on Apr. 16, 2015.

(51) Int. Cl. C04B 9/20; C04B 9/04; C04B 9/11

(52) U.S. Cl. CPC C04B 9/20; C04B 9/11; C04B 9/04; C04B 2111/00586

(57) ABSTRACT

Magnesium based cements are provided using one or more slurry precursors. In an embodiment, a method of forming a magnesium-based cement includes providing an aqueous slurry of a magnesium compound. A magnesium cement co-reactant is also provided. The aqueous slurry of the magnesium compound is mixed with the magnesium cement co-reactant to provide the magnesium-based cement.

### CROSS-REFERENCE TO RELATED APPLICATIONS

This application claims the benefit of U.S. provisional patent application Ser. No. 62/148,285, entitled “MgO and Mg(OH)₂ Slurries for Mg-Based Cements,” filed on Apr. 16, 2015, the entire disclosure of which is incorporated herein by reference.

### TECHNICAL FIELD

The present disclosure generally relates to magnesium-based cements, and more particularly relates to slurry precursors for magnesium-based cements, and magnesium-based cements formed therefrom.

### BACKGROUND OF THE DISCLOSURE

Magnesium-based cements have been developed and commercially used for decades. These magnesium-based cements can often exhibit unique properties due to the associated properties of magnesium, such as fire resistance, mold and mildew resistance, insect repellency, and strong matrix adhesion to just about any filler material. These unique properties available from magnesium-based cements have led to the development of light weight and durable building products such as construction boards, flooring products, tiles, coatings, siding and roofing products, and a variety of other related materials.

Magnesium-based binder systems (e.g., magnesium-based cements) may often be used as alternative binder systems to those based on Ordinary Portland Cements (OPC) for making cements, mortars and concrete building products. Magnesium-based cements are typically produced using powered magnesium oxide, which is blended with dry or liquid components and then water, to initiate the reactions that lead to the magnesium-based cement. Examples of such formulations may generally include the reaction of dry, powdered magnesium oxide with flakes or liquid magnesium chloride brine, and water to produce magnesium oxychloride cements (MOC). Similarly, dry, powdered magnesium oxide and anhydrous or magnesium sulfate hydrate (MgSO₄ hydrate) and water may be reacted to produce magnesium oxysulfate cements (MOC). Dry, powdered magnesium oxide may be reacted with powered or liquid phosphates and water to produce magnesium phosphate cements (MPC). According to a further variety, dry, powdered magnesium oxide may be reacted with various silicates (e.g., various forms of SiO₂) and water to produce magnesium silicate cements (MSC).

In general, although desired physical and chemical properties can be achieved when producing magnesium-based cement mixtures, consistency and reproducibility have often times been difficult to achieve. Such issues of non-consistency issues may be attributed, at least in part, due to the variability of raw materials, including surface area reactivities, temperature variations, particle size variations, dry mixing inconsistencies, static discharging, heat of hydration reactions and inconsistencies in acid to base and water to cement ratios. Such variations and inconsistencies may result in inconsistent reactions between the magnesium oxide components and the co-reactants. Such inconsistencies can be particularly problematic when producing Magnesium Phosphate Cements (MPC), for example because the reaction between magnesium oxide and phosphates is highly reactive producing a high heat of hydration exothermic reaction when the components are subsequently mixed with water.

### SUMMARY

According to an implementation new chemistries and/or processes are provided that may minimize and/or overcome (partially or completely) problems and/or challenges associated with conventional magnesium-based cement systems. In some implementations, systems and method may provide for a more consistent and/or controlled reactions, e.g., which may allow for more reproducible cement properties in batch, and/or continuous manufacturing processes. According to one implementation, a method of forming a magnesium-based cement may include providing an aqueous slurry of a magnesium compound. A magnesium cement co-reactant may also be provided. The aqueous slurry of the magnesium compound may be mixed with the magnesium cement co-reactant. The resultant mixture may, ultimately form the magnesium-based cement.

One or more of the following features may be included. The magnesium compound may include one or more of magnesium oxide and magnesium hydroxide. The magnesium compound may include one or more of dead burned magnesium oxide, hard burned magnesium oxide, light burned magnesium oxide, and flash calcined magnesium oxide. The magnesium compound may include one or more of Brucite, Brucitic marble, fully hydrated magnesium oxide, partially hydrated magnesium oxide, and synthetic magnesium oxide produced by alkali precipitation from one or more of magnesium containing brines and seawater.

Providing the aqueous slurry of the magnesium compound includes providing the aqueous slurry at a predetermined temperature. The predetermined temperature may include a temperature of between about 40° F. to about 140° F. The aqueous slurry of the magnesium compound may include a dispersing agent capable of producing a stable slurry. The dispersing agent may include one or more of a polyacrylate, a polyacrylamide, a polyacrylic/polyacrylamide copolymer, and one or more of an anionic, a cationic, a nonionic, and an amphoteric surfactant. The aqueous slurry of the magnesium compound may include a viscosity control agent capable of producing a stable, slurry having a relatively higher magnesium compound concentration. The viscosity control agent may include one or more of a carbohydrate-based mono-saccharide, a di-saccharide, a polysaccharides, a polyhydric alcohol, and one or more of an ethoxylated and a non-ethoxylated polyhydric alcohol based surfactants.

Providing the aqueous slurry of the magnesium compound may include one or more of pre-dispersing the magnesium compound and at least partially pre-hydrating the magnesium compound. Providing the aqueous slurry of the magnesium compound may include pre-hydrating the magnesium compound to provide a magnesium oxide to magnesium hydroxide ratio of between about 95% magnesium oxide to 5% magnesium hydroxide to about 0% magnesium oxide to about 100% magnesium hydroxide. Providing the magnesium cement co-reactant may include providing the magnesium cement co-reactant as an aqueous slurry including the magnesium cement co-reactant. Providing the magnesium cement co-reactant as an aqueous slurry may include one or more of pre-dispersing the magnesium cement co-reactant and at least partially pre-hydrating the magnesium cement co-reactant.

The magnesium cement co-reactant may include one or more of an oxychloride co-reactant, an oxysulfate co-reactant, a phosphate co-reactant, and a silicate co-reactant. The phosphate co-reactant may include an organo-phosphate including one or more of a mono-potassium phosphate, an ammonium mono-hydrogen phosphate, an ammonium dihydrogen phosphate, a diammonium phosphate, an ammonium polyphosphate, a potassium mono-hydrogen phosphate, a potassium di-hydrogen phosphate, an aluminum phosphate, an ortho-phosphate, an aluminum polyphosphate, an aluminum phosphonate, an ammonium polyphosphate, a pyrophosphate, a polyphosphate, a potassium pyrophosphate, a phosphoric acids, an organic phosphate acids, and a phosphonates.

The aqueous slurry of the magnesium compound may include from between about 5% to about 90% magnesium compound solids by weight of the slurry. The aqueous slurry of the magnesium compound may include from between about 50% to about 70% magnesium compound solids by weight of the slurry. The method may also include providing one or more retarders capable of increasing a working time of the magnesium-based cement. The one or more retarders may include one or more of cold water, a borate, a boric acid, a hydrochloric acid, a sulfuric acid, a citrate, a tartrates, an organic acid, and a salt of an organic acid.

According to another implementation, a method of forming a magnesium-based cement may include providing an aqueous slurry of a magnesium cement co-reactant. The method may also include providing a magnesium compound. The method may further include mixing the aqueous slurry of the magnesium cement co-reactant with the magnesium compound.

### BRIEF DESCRIPTION OF THE DRAWINGS

FIG. 1 diagrammatically depicts a continuous process for manufacturing magnesium-based cement board according to an example implementation of the present disclosure.

### DESCRIPTION OF EXAMPLE IMPLEMENTATIONS

In general, the present disclose may provide magnesium-based cements formed from slurry precursors of one or both of the magnesium compound and/or the magnesium cement co-reactant, and methods of producing magnesium-based cements that may utilize slurry precursors of one or both of the magnesium compound utilized in the magnesium-based cement and/or of the magnesium cement co-reactant. In some instances, the slurry precursors may at least partially, and/or may fully, pre-hydrate the magnesium compound (e.g., which may include one or more of magnesium oxide (i.e., MgO) and magnesium hydroxide (i.e., Mg(OH)₂)) and/or may at least partially pre-hydrate one or more magnesium cement co-reactants or other binder components. Consistent with such implementations, it may be possible to provide magnesium-based cements that have relatively highly reproducible properties and reaction characteristics. Such comparatively high reproducibility may allow relatively consistent and uniform building product and application characteristics to be achieved. Further, in some situation, improved results may be achieved by introducing the magnesium compound into the magnesium-based cement process homogeneously pre-dispersed in water, and controlling the subsequent reactions, e.g., by closely maintaining a consistent hydration ratio of the aqueous slurries.

As generally discussed above, according to an implementation a method of forming a magnesium-based cement may include providing an aqueous slurry of a magnesium compound. A magnesium cement co-reactant may also be provided. The aqueous slurry of the magnesium compound may be mixed with the magnesium cement co-reactant. The resultant mixture may, ultimately form the magnesium-based cement. As described in greater detail below, the magnesium cement co-reactant may include one or more compounds that may engage in chemical reactions to produce the magnesium-based cements. The magnesium cement co-reactants may react with the magnesium compound, may react with another component of the magnesium-based cement, or may react both with the magnesium compound and with another component of the magnesium-based cement.

The systems and method disclose herein may utilize different forms of magnesium compounds. For example, the magnesium compound may include magnesium oxide, magnesium hydroxide, and/or mixtures of magnesium oxide and magnesium hydroxide. In some implementations, the ability to use different forms of magnesium compound may be advantageous compared to conventional systems that may typically only be capable of utilizing un-hydrated magnesium oxide power as the controlled reactants, along with various co-reactants to produce magnesium-based cements. In some embodiments, methods may utilize magnesium compounds that may include magnesium oxide in the form of partially and/or fully hydrated magnesium oxide slurries, and/or magnesium hydroxide slurries that may be derived from brine extraction and precipitation, powdered or dispersed Brucite, and/or other related forms. In some implementations, the use of magnesium compound slurries may allow for more controlled reaction parameters when making magnesium-based cements, e.g., as compared to processes that may use dry powdered magnesium oxide.

According to various implementations, and as generally described above, various forms of magnesium compound may be used to provide the aqueous slurry of the magnesium compound. In some embodiments, the magnesium compound may include one or more of dead burned magnesium oxide, hard burned magnesium oxide, light burned magnesium oxide, and flash calcined, or light burned magnesium oxide. In general, such designations may generally relate to the temperature and process through which Magnesite (e.g., magnesium carbonate mineral) is calcined by burning off the carbon dioxide to produce the desired grade of magnesium oxide. Such calcined versions of magnesium oxide may be typically referred to as naturally occurring forms of magnesium oxide. In some implementations, the magnesium compound may also include magnesium oxide that may be derived from the extraction of magnesium ions from sea or brine waters and precipitated to form magnesium oxide or magnesium hydroxide. Such precipitated varieties may often be referred to as synthetic grades of magnesium oxide.

Continuing with the foregoing, in some implementations, the magnesium compound may include one or more of Brucite, Brucitic marble, fully hydrated magnesium oxide, partially hydrated magnesium oxide, and synthetic magnesium oxide produced by alkali precipitation from one or more of magnesium containing brines and seawater. As is generally understood, Brucite is a naturally occurring mineral form of magnesium hydroxide that is mined and ground to a desired particle size. Although Brucite is typically provided as a dry powder, it can also be used and is contemplated in connection with some implementations. Dispersing the Brucite powder into an aqueous slurry may generally be more preferred in some implementations, as aqueous slurry form of Brucite powder may often be more effective for controlling reactivity on a more consistent basis.

As generally discussed above, providing the aqueous slurry of the magnesium compound may include one or more of pre-dispersing the magnesium compound and at least partially pre-hydrating the magnesium compound. For example, the magnesium compound may include, in full or in part, magnesium oxide. In some instances, providing the aqueous slurry of the magnesium compound may include pre-hydrating at least a portion of the magnesium oxide to form magnesium hydroxide. Pre-hydrating the magnesium oxide to provide a mixed magnesium oxide/magnesium hydroxide hydrated aqueous dispersion may allow for a variety of new options for the formulator in controlling preferred reactivities and ultimate properties. When pre-mixing magnesium oxide with water to form the aqueous slurry, a hydration reaction may begin almost immediately, converting the magnesium oxide to magnesium hydroxide at a controlled or uncontrolled rate. The general reaction chemistry is as follows:

MgO+H₂O=Mg(OH)₂

The time and rate in which this conversion occurs may be controlled by temperature, the type of water used, dispersing agents, viscosity control agents, hydration or hydrolysis accelerators, hydration retarders and/or other additives. In some implementations, the ratio of resultant magnesium oxide to magnesium hydroxide in the resultant slurry may also be controlled for consistency, for example, using the above additives. According to various implementations, providing the aqueous slurry of the magnesium compound may include pre-hydrating the magnesium compound to provide a magnesium oxide to magnesium hydroxide ratio of between about 95% magnesium oxide to 5% magnesium hydroxide to about 0% magnesium oxide to about 100% magnesium hydroxide.

In some implementations, providing the aqueous slurry including the magnesium compound may include pre-dispersing the magnesium compound. For example, in some situations at least a portion of the magnesium compound included in the aqueous slurry may include fully hydrated magnesium hydroxide, may include non-hydrated magnesium oxide, or, as described above, may include a combination of fully hydrated magnesium oxide and non-hydrated magnesium oxide. In such situations, the magnesium compound may be pre-dispersed to provide the aqueous slurry. In some implementations, the magnesium compound may be pre-dispersed to provide a generally homogeneous slurry. In some situations, continuous and/or intermittent mixing may be employed to achieve, and/or maintain, the generally homogeneous slurry.

The active concentrations of each dispersion may be important, especially when large volume continuous processes are encountered in applications such as producing high volume construction boards. For example, relatively higher active concentration of the slurry, may provide better results in such circumstances, as shipping water across a wide region can be cost restrictive (e.g., due to the additional volume and weight of the water in relatively lower active concentration slurries, which may increase shipping costs). Additionally, the ultimate water content in the final cement mix can be an important factor in the reaction between the magnesium compound and the magnesium cement co-reactants. It will be appreciated that the water content in the aqueous slurry, which may be mixed to form the magnesium-based cement, must be considered as part of the water content in the final cement mix. As such, the water content in the aqueous slurry may affect the physical, mechanical, and/or chemical properties of the final resultant magnesium-based cement. In some implementations, the aqueous slurry of the magnesium compound may include from between about 5% to about 90% magnesium compound solids by weight of the slurry. In some particular implementations, the aqueous slurry of the magnesium compound may include from between about 50% to about 70% magnesium compound solids by weight of the slurry.

As generally discussed above, it may be desirable to provide the aqueous slurry including the magnesium compound as a generally homogeneous slurry, e.g., having the magnesium compound generally evenly dispersed within the aqueous phase. It will be appreciated that some degree of separation may occur. As such various mixing operations and additives may be employed to increase the homogeneity of the slurry, including mixing operations implemented prior to and/or during combination with the magnesium cement co-reactants. In some situations, e.g., for making higher concentrated magnesium oxide and/or magnesium hydroxide slurries, it may often be difficult to obtain a stable dispersion when content of active components (e.g., the magnesium compound) exceed 50 to 60%. Accordingly, in some embodiments the aqueous slurry of the magnesium compound may include a dispersing agent capable of producing a stable slurry, and/or a more stable slurry than would be achieved without the use of the dispersing agents. In some embodiments, the dispersing agent may include one or more of a polyacrylate, a polyacrylamide, a polyacrylic/polyacrylamide copolymer, and one or more of an anionic, a cationic, a nonionic, and an amphoteric surfactant.

In addition to, or as an alternative to, a dispersing agent, a viscosity control agent may be utilized to aid in providing the aqueous slurry as a stable dispersion. Accordingly, the aqueous slurry of the magnesium compound may include a viscosity control agent capable of producing a stable slurry, particularly for slurries having a relatively higher magnesium compound concentration. The viscosity control agent may include one or more of a carbohydrate-based mono-saccharide, a carbohydrate-based di-saccharide, a carbohydrate-based polysaccharides, a polyhydric alcohol, and one or more of an ethoxylated and a non-ethoxylated polyhydric alcohol based surfactants.

In some embodiments, a high shear mixer, such as a Munson mixer, may be utilized to disperse the active component for a set period of time at a set level of rpm's (Revolutions Per Minute). Additionally, the temperature of the mix water used for making the slurry may be controlled, or varied, to achieve a desired slurry concentration. In such embodiments, providing the aqueous slurry of the magnesium compound may include providing the aqueous slurry at a predetermined temperature. The predetermined temperature may include a temperature of between about 40° F. to about 140° F. For example, in an illustrative embodiment, an aqueous slurry may be provided heating the mix water to between 100° F. to 135° F. Further, in some embodiments, pre-grinding the magnesium compound may be utilized to obtain a stable dispersion and controllable rate of hydration. In these cases, pre-grinding the magnesium compound may achieve a desired particle size distribution, surface area, etc. According to one illustrative example, the magnesium compound may be ground to a particle size at which 98% of the ground magnesium compound may pass a 325 mesh (e.g., 45 micron), and may have a specific surface area on the order of 35 m²/g. Of course, it will be recognized that other particle sizes and specific surface areas may suitably be used.

As generally discussed above, the magnesium cement co-reactant may include one or more components that may chemically react with the magnesium compound, with other components of the cement mix (which may include reaction intermediaries), or both with the magnesium compound and other components of the cement mix to produce the final magnesium-based cement. According to various embodiments, the magnesium cement co-reactant may include one or more of an oxychloride co-reactant, an oxysulfate co-reactant, a phosphate co-reactant, and a silicate co-reactant. Consistent with the foregoing, the magnesium compound and the magnesium cement co-reactant may generally resulting in one or more of magnesium phosphate cements (MPC), magnesium oxychloride cements (MOC), magnesium oxysulfate cements (MOS), magnesium silicate cements, gypsum cements, stucco cements, Portland cement types, calcium aluminate and calcium sulfa aluminate cements. In particular implementations for providing magnesium phosphate cements, the phosphate co-reactant may include an organo-phosphate including one or more of a mono-potassium phosphate, an ammonium mono-hydrogen phosphate, an ammonium dihydrogen phosphate, a diammonium phosphate, an ammonium polyphosphate, a potassium mono-hydrogen phosphate, a potassium di-hydrogen phosphate, an aluminum phosphate, an ortho-phosphate, an aluminum polyphosphate, an aluminum phosphonate, an ammonium polyphosphate, a pyrophosphate, a polyphosphate, a potassium pyrophosphate, a phosphoric acids, an organic phosphate acids, and a phosphonates.

Consistent with the present disclosure, it has been found that it may be possible to achieve improved reproducibly of consistent cement properties by pre-dispersing the magnesium cement co-reactants (e.g., other reactive components such as phosphate, magnesium chloride, sulfate, gypsum, silicate, etc.) into water. As such, providing the magnesium cement co-reactant may include providing the magnesium cement co-reactant as an aqueous slurry including the magnesium cement co-reactant. In some embodiments, providing the magnesium cement co-reactants as an aqueous slurry may provide a consistent hydration and active concentration. The subsequent mixing of the magnesium compound and/or magnesium cement co-reactant aqueous dispersions/slurries together may reduce and/or minimize the initial “shock” effect of each component when being introduced separately with water. In this regards, pre-dispersing/hydration steps is believed to break the surface tension of the individual materials which can then react together in a much more controlled manner. In some particular embodiments, the more controlled reactions available by providing each of the magnesium compound and the magnesium cement co-reactant as an aqueous slurry may be beneficial, e.g., when a continuous production process is utilized such as on a construction board assembly line, but also may be important for consistency in batch or in-field mixing, such as for use as a quick-setting concrete bridge deck repair patch application.

Consistent with the foregoing, providing the magnesium cement co-reactant as an aqueous slurry may include one or more of pre-dispersing the magnesium cement co-reactant and at least partially pre-hydrating the magnesium cement co-reactant. For example, depending upon the nature of the magnesium cement co-reactants, the co-reactants may be dispersed in the aqueous phase. Further, for some magnesium cement co-reactants one or more hydration reactions may occur, through which such co-reactants may be partially, or completely, hydrated by providing the magnesium cement co-reactant as an aqueous slurry. In a similar manner as discussed above, one or more dispersing agents may be utilized to aid in providing a generally consistent dispersion including the magnesium cement co-reactant at a desired concentration. Additionally, or alternatively, one or more viscosity control agents may be utilized to aid in providing a generally consistent dispersion including the magnesium cement co-reactant at a desired concentration. Dispersing agents and/or viscosity control agents that may be suitably used in connection with the magnesium cement co-reactants may include, but are not limited to, those dispersing agents and viscosity control agents described above in connection with the aqueous slurries including the magnesium compounds.

In a similar manner as discussed with respect to the aqueous slurries including the magnesium compounds, in some embodiments, a high shear mixer, such as a Munson mixer, may be utilized to disperse the active component for a set period of time at a set level of rpm's (Revolutions Per Minute). Additionally, the temperature of the mix water used for making the slurry may be controlled, or varied, to achieve a desired slurry concentration. In such embodiments, providing the aqueous slurry of the magnesium cement co-reactant may include providing the aqueous slurry at a predetermined temperature. The predetermined temperature may include a temperature of between about 40° F. to about 140° F. For example, in an illustrative embodiment, an aqueous slurry may be provided heating the mix water to between 100° F. to 135° F. Further, in some embodiments, pre-grinding the magnesium cement co-reactant may be utilized to obtain a stable dispersion and controllable rate of hydration. In these cases, pre-grinding the magnesium compound may achieve a desired particle size distribution, surface area, etc. Additionally, and as generally mentioned, the amount of required mix water for each magnesium-based cement may be extremely important for achieving desired properties. Some example ranges of solids content some illustrative dispersion/slurry may include:

MgO/Mg(OH)₂—10 to 80%

Phosphates—10 to 60%

MgCl₂—10 to 50%

Gypsum/Stucco—5 to 70%

Silicates—5 to 60%

It will be appreciated that the above values are intended only for the purpose of illustration. Suitable solids content for slurries including various components may vary based upon, for example, the exact cement mix composition, the total water content of all components, desired mechanical, physical, and chemical properties of the resulting cement, necessary work times for the cement mix, as well as various additional and/or alternative considerations.

In addition to the above-described embodiments, in which the magnesium compounds may be provided in an aqueous slurry, the magnesium cement co-reactants may be provided as dry components (e.g., powder, flake, etc.), liquid components, and/or provided in an aqueous slurry. In some embodiments consistent with the present disclosure, the magnesium cement co-reactants may be provided in an aqueous slurry, and the magnesium compound may be provide as a dry component, or may be provided in an aqueous slurry. Accordingly, a method of forming a magnesium-based cement may include providing an aqueous slurry of a magnesium cement co-reactant. The method may also include providing a magnesium compound. The method may further include mixing the aqueous slurry of the magnesium cement co-reactant with the magnesium compound.

Controlling the rate of the reaction may be desirable for achieving desired physical, mechanical, and/or chemical properties in the final magnesium-based cement. Further, controlling the rate of reaction may also be used for providing a desired working time. For example, in a continuous production process, such as for manufacturing sheet construction products, a comparatively fast reaction rate may be acceptable, or even beneficial. In other applications, such as applications requiring in field mixing and placement of the cement, a relatively slower reaction rate, and therefore longer working time, may be desirable. Consistent with the present disclosure, one or more retarders capable of increasing a working time of the magnesium-based cement may be used. In some example embodiments, the one or more retarders may include one or more of cold water (e.g., water in the temperature range of between about 35° F. to about 65° F.), a borate, a boric acid, a hydrochloric acid, a sulfuric acid, a citrate, a tartrates, an organic acid, and a salt of an organic acid. Various additional and/or alternative retarders may be utilized. Further, various other additives may be included in the cement mix to adjust the physical, mechanical or chemical properties.

Consistent with some example embodiments, the present disclosure may be suitable applied to use in connection with magnesium phosphate cements. For example, many magnesium-based cements may have specific issues relating to the use and handling of the cements. However, the production of conventional Magnesium Phosphate Cements (MPC) have generally been the most problematic. For example, of the various types of magnesium-based cements, controlling the rate of reaction for MPC often proves to be among the most difficult tasks. Often, due to the reactions involved, MPC can set-up quickly and only provide open working times in the range of between seconds to a few minutes. The choice of magnesium compound and the phosphate may be critical in determining the cement preparation and preferred performance characteristics. Various attempts have been made to slow down (retard) the highly exothermic acid-base reaction of the dry phosphate and the dry powdered magnesium oxide, thus allowing for longer working times. Prolonging initial set-times can be accomplished by using retarding agents such as borates or boric acid, however, other physical properties of the resultant binder matrix can be negatively affected, such as a reduction in compressive strength. Consistent with the present disclosure, using an aqueous, pre-dispersed, pre-hydrated magnesium oxide or magnesium hydroxide slurry may be utilized to reduce, minimize, and/or eliminate these negatives. Further, it has also been found that pre-dispersing the phosphate co-reactant can also provide more controllable and consistent results. Therefore, producing an aqueous slurry of the phosphate and mixing with an aqueous slurry of the magnesium oxide and/or magnesium hydroxide may provide more controlled reactions and greater ease of use of MPC, as compared to conventional techniques. Examples of phosphates that can be pre-dispersed/pre-hydrated may include, but are not limited to:

Mono-potassium phosphate (MKP)

Ammonium mono and dihydrogen phosphate

Diammonium phosphate

Ammonium polyphosphate

Potassium mono- and di-hydrogen phosphate

Aluminum phosphates

Ortho-phosphates

Aluminum polyphosphates

Aluminum phosphonate

Ammonium polyphosphate

Pyrophosphates

Polyphosphates and phosphonates, such as potassium pyrophosphate

Phosphoric acids

Organic phosphate acids

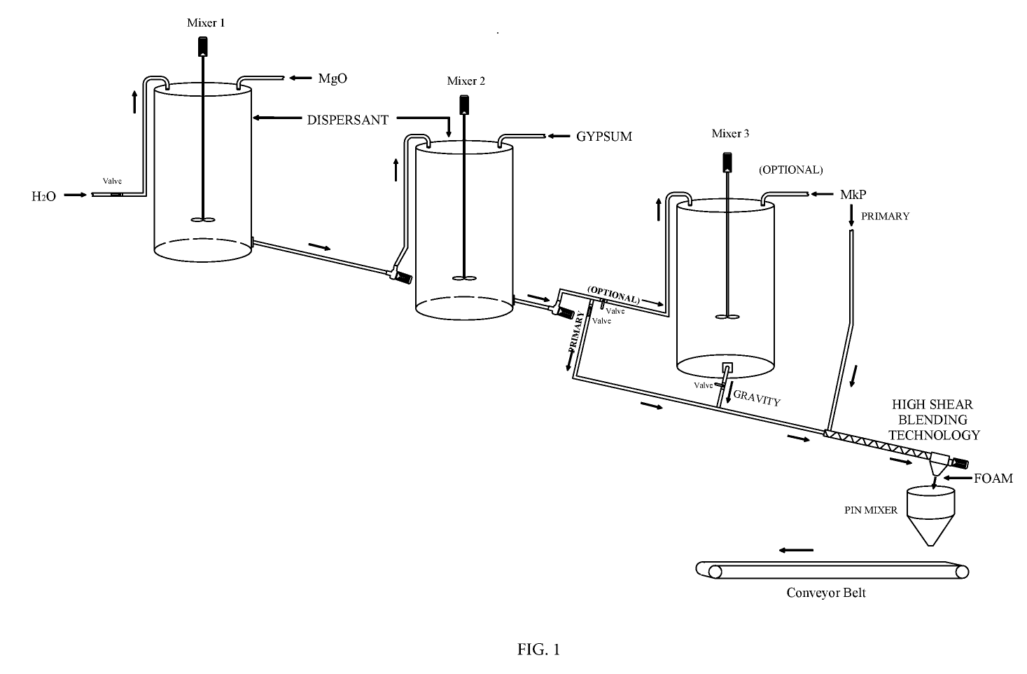

In one embodiment, a hybrid magnesium cement may be formulated consisting of a 60% magnesium oxide slurry, mixed with a separate stucco/gypsum slurry and may include the addition of 15% mono-potassium phosphate to make a Magnesium Phosphate/Gypsum construction wall board. Due to a previously tried non-slurry approaches, whereby dry components were mixed and then added to water, it was discovered that multiple simultaneous chemistries appear to be occurring that were not fully understood and yielded uncontrolled and inconsistent results. Consistent with the present disclosure, a process, as generally illustrated in FIG. 1, was developed to provide a continuous process that would add and pre-disperse/pre-hydrates each component separately via independent slurry or water tanks. For example, as shown in FIG. 1, a magnesium compound (in the form of magnesium oxide in the illustrated example) and water may be combined in Mixer 1 to provide an aqueous slurry including the magnesium compound. As generally described above, the aqueous slurry may at least partially hydrate the magnesium oxide and may pre-disperse the at least partially hydrated magnesium oxide/magnesium hydroxide. Further, the magnesium compound slurry may be combined with gypsum in Mixer 2. While not shown, in some embodiments, the gypsum may be mixed with water to form a slurry prior to being mixed with the aqueous slurry including the magnesium compound. Further, as an optional step, the mono-potassium phosphate may be combined with the mixture of magnesium compound slurry and gypsum in Mixer 3. While not shown, in some embodiments the mono-potassium phosphate may be mixed with water to form a slurry prior to being mixed with the mixture of the aqueous slurry including the magnesium compound and the gypsum. Further, the combination of the aqueous slurry including the magnesium compound, the gypsum, and the mono-potassium phosphate may be mixed using a suitable high shear mixer (e.g., High Shear Blending Technology in FIG. 1). The mixed components discharged from the high shear mixer may be foamed and further combined in a Pin Mixer and may be dispensed as a sheet onto a conveyer belt assembly. As such, a continuous sheet of magnesium-gypsum (and optionally mono-potassium phosphate) cement may be produced.

In the example process, it may be possible to achieve a desired degree of consistency, retention times, and mixing ratios for highly consistent, homogeneous magnesium cement board with a high degree of reproducibility. Consistent with the example process, the introduction of the magnesium oxide/magnesium hydroxide reactant in a pre-hydrated slurry form, and then adding to this slurry a stucco/gypsum mixture is believed to contribute to the favorable and consistent results.

In addition to the foregoing, the pre-dispersed slurry system may provide a significantly improved workable mix. Conventional dry conditions (e.g., without using slurries) may often be very thixotropic, and may give false sets, and may significantly liquefy under shear. However, the slurry process consistent with the present disclosure may allow a more workable mix with flow characteristics that may be suitable to continuous processes. Further, such a pre-dispersed slurry approach may also allow for stoppage during continuous production while reducing and/or eliminating any problems such as the cement materials setting up and clogging the lines. This ability may be particularly beneficial, e.g., when large volume continuous or batch production processes are in use.

As generally alluded to in the foregoing example, in addition to pure magnesium-based cement systems, there are also hybrid magnesium-based cement systems that, in conventional processes, utilize dry powdered magnesium oxide along with one or all of the previously listed magnesium cement co-reactants. Such hybrid systems may also be further cross reacted with more standard cement precursors such as stucco, gypsum, Portland Cement, calcium aluminates, calcium sulfaaluminates (CSA) or others. In general, although desired physical and chemical properties can be achieved when producing these magnesium-based cement mixtures, consistency and reproducibility have often times been difficult to achieve. These non-consistency issues of using dry blended raw feed materials may be attributed to the variability of raw materials, including surface area reactivities, temperature variations, particle size variations, dry mixing inconsistencies, static discharging, heat of hydration reactions, and acid : base and water : cement ratio inconsistencies. Such non-consistent reactions have been especially problematic when producing magnesium phosphate cements (MPC) as the reaction between magnesium oxide and phosphate is highly reactive producing a high heat of hydration exothermic reaction when the components are subsequently mixed with water. Consistent with the present disclosure, such inconsistencies may be partially and/or fully alleviated by providing the magnesium compound, the magnesium cement co-reactant, or both the magnesium compound and the magnesium cement co-reactant as a slurry, which may be at least partially pre-hydrated and/or pre-dispersed, as described herein.

Consistent with the foregoing disclosure, various example implementations are provided below. Such examples are provided for the purpose of illustration, and not of limitation.

### EXAMPLE 1

In one embodiment, a 60% concentrated Mg(OH)2 slurry with a 50% MKP slurry was used to produce a workable in-field MPC for use as a concrete bridge deck patch cement. It was found that this formula provided slower set-times, more consistent reactivity and performance compared to using a powdered MgO with a powdered MKP and then adding water. The formula in this embodiment consists of the following:

30% of a 60% concentrated fully hydrated Mg(OH)₂ slurry

30% of a 50% concentrated pre-dispersed MKP slurry

4.0% Boric Acid

20% Sand

16% Metakaolin

### EXAMPLE 2

In one embodiment, a Magnesium Silicate/Magnesium Phosphate hybrid cement (MSC/MPC) was produced based on the following:

30-60% silica fume

24-36% of a 60% Mg(OH)₂ slurry

1-5% sodium silicate

1-2% sodium hexametaphosphate

### EXAMPLE 3

In one embodiment, a Magnesium OxyCloride (MOC) cement was produced based on the following composition:

31% of a 60% magnesium hydroxide slurry

19% of a Magnesium chloride hexahydrate flake

45% Sand

5% Metakaolin

There are many magnesium-based cement applications where the processes of the present disclosure can be beneficially applied. Example of such applications and use cases may include, but are not limited to, continuous and batch processes for making construction boards such as wall boards, floor boards, backer boards, ceiling tiles, siding products, roof products, etc. Additionally, methods and resultant magnesium-based cements according to the present disclosure may be used in connection with acid resistant protective coatings for construction boards, tunnels, sewer systems, etc. Methods, systems, and products consistent with the present disclosure may also be used in connection with 3-D printing applications, pool plaster and gunite/shotcrete materials, tile grouts and mortars, quick-setting concrete patching such as bridge decks, structural and non-structural walls and roofs, oil and gas drilling concrete or cement wells, heat resistant airport or military runway applications, concrete blocks, compressed soil blocks, bricks and tiles, soil stabilization, and remediation and stabilization of hazardous waste. The systems, methods, and products of the present disclosure may find wide applicability in other applications as well.

A number of implementations have been described. Nevertheless, it will be understood that various modifications may be made. Accordingly, other implementations are within the scope of the following claims.

What is claimed is:

1. A method of forming a magnesium-based cement comprising:
providing an aqueous slurry of a magnesium compound;
providing a magnesium cement co-reactant; and
mixing the aqueous slurry of the magnesium compound with the magnesium cement co-reactant.

2. The method according to claim 1, wherein the magnesium compound includes one or more of magnesium oxide and magnesium hydroxide.

3. The method according to claim 2, wherein the magnesium compound includes one or more of dead burned magnesium oxide, hard burned magnesium oxide, light burned magnesium oxide, and flash calcined magnesium oxide.

4. The method according to claim 2, wherein the magnesium compound includes one or more of Brucite, Brucitic marble, fully hydrated magnesium oxide, partially hydrated magnesium oxide, and synthetic magnesium oxide produced by alkali precipitation from one or more of magnesium containing brines and seawater.

5. The method according to claim 1, wherein providing the aqueous slurry of the magnesium compound includes providing the aqueous slurry at a predetermined temperature.

6. The method according to claim 5, wherein the predetermined temperature is between about 40° F. to about 140° F.

7. The method according to claim 1, wherein the aqueous slurry of the magnesium compound includes a dispersing agent capable of producing a stable slurry.

8. The method according to claim 7, wherein the dispersing agent includes one or more of a polyacrylate, a polyacrylamide, a polyacrylic/polyacrylamide copolymer, and one or more of an anionic, a cationic, a nonionic, and an amphoteric surfactant.

9. The method according to claim 1, wherein the aqueous slurry of the magnesium compound includes a viscosity control agent capable of producing a stable, slurry having a relatively higher magnesium compound concentration.

10. The method according to claim 9, wherein the viscosity control agent includes one or more of a carbohydrate-based mono-saccharide, a di-saccharide, a polysaccharides, a polyhydric alcohol, and one or more of an ethoxylated and a non-ethoxylated polyhydric alcohol based surfactants.

11. The method of claim 1, wherein providing the aqueous slurry of the magnesium compound includes one or more of pre-dispersing the magnesium compound and at least partially pre-hydrating the magnesium compound.

12. The method of claim 11, wherein providing the aqueous slurry of the magnesium compound includes pre-hydrating the magnesium compound to provide a magnesium oxide to magnesium hydroxide ratio of between about 95% magnesium oxide to 5% magnesium hydroxide to about 0% magnesium oxide to about 100% magnesium hydroxide.

13. The method according to claim 1, wherein providing the magnesium cement co-reactant includes providing the magnesium cement co-reactant as an aqueous slurry including the magnesium cement co-reactant.

14. The method according to claim 13, wherein providing the magnesium cement co-reactant as an aqueous slurry includes one or more of pre-dispersing the magnesium cement co-reactant and at least partially pre-hydrating the magnesium cement co-reactant.

15. The method according to claim 1, wherein the magnesium cement co-reactant includes one or more of an oxychloride co-reactant, an oxysulfate co-reactant, a phosphate co-reactant, and a silicate co-reactant.

16. The method according to claim 15, wherein the phosphate co-reactant includes an organo-phosphate including one or more of a mono-potassium phosphate, an ammonium mono-hydrogen phosphate, an ammonium dihydrogen phosphate, a diammonium phosphate, an ammonium polyphosphate, a potassium mono-hydrogen phosphate, a potassium di-hydrogen phosphate, an aluminum phosphate, an ortho-phosphate, an aluminum polyphosphate, an aluminum phosphonate, an ammonium polyphosphate, a pyrophosphate, a polyphosphate, a potassium pyrophosphate, a phosphoric acids, an organic phosphate acids, and a phosphonates.

17. The method according to claim 1, wherein the aqueous slurry of the magnesium compound includes from between about 5% to about 90% magnesium compound solids by weight of the slurry.

18. The method according to claim 17, wherein the aqueous slurry of the magnesium compound includes from between about 50% to about 70% magnesium compound solids by weight of the slurry.

19. The method according to claim 1, further comprising providing one or more retarders capable of increasing a working time of the magnesium-based cement, the one or more retarders including one or more of cold water, a borate, a boric acid, a hydrochloric acid, a sulfuric acid, a citrate, a tartrates, an organic acid, and a salt of an organic acid.

20. A method of forming a magnesium-based cement comprising:
providing an aqueous slurry of a magnesium cement co-reactant;
providing a magnesium compound; and
mixing the aqueous slurry of the magnesium cement co-reactant with the magnesium compound.
